(19) United States
(12) Patent Application Publication
(10) Pub. No.: US 2023/0356442 A1
(43) Pub. Date: Nov. 9, 2023

(54) VIBRATION ISOLATING AND DAMPING MEMBER AND MANUFACTURING METHOD THEREOF

(71) Applicant: Sumitomo Riko Company Limited, Aichi (JP)

(72) Inventors: Yuka NAGAI, Aichi (JP); Junki OWAKI, Aichi (JP); Satoshi MAKIMURA, Aichi (JP); Takamichi YAMAMOTO, Aichi (JP); Koji MIZUTANI, Aichi (JP); Junichiro SUZUKI, Aichi (JP); Kiyoshi SAKAI, Aichi (JP)

(73) Assignee: Sumitomo Riko Company Limited, Aichi (JP)

(21) Appl. No.: 18/355,388

(22) Filed: Jul. 19, 2023

Related U.S. Application Data
(63) Continuation of application No. PCT/JP2022/043120, filed on Nov. 22, 2022.

(30) Foreign Application Priority Data
Mar. 30, 2022 (JP) 2022-057377

(51) Int. Cl. B29C 44/02; B29C 44/34

(52) U.S. Cl. CPC B29C 44/02; B29C 44/3461; B29C 44/3442; B29K 2075/00

(57) ABSTRACT

A vibration isolating and damping member that is excellent in mechanical properties such as high-temperature durability, is excellent in reusability, and is capable of reducing manufacturing costs, and a manufacturing method thereof are provided. The vibration isolating and damping member is formed of polyurethane, a polyol component of the polyurethane includes a polyester-based polyol excluding a short-chain polyol, an isocyanate component of the polyurethane contains 1,5-naphthalenediisocyanate as a main component, and the vibration isolating and damping member is formed of a foam of a thermoplastic urethane composition having an NCO index of 0.9 to 1.04.

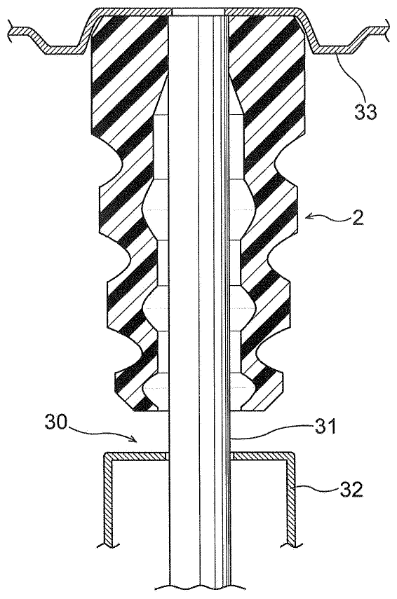

### CROSS-REFERENCE TO RELATED APPLICATION

This application is a continuation application of International Application number PCT/JP2022/043120 on Nov. 22, 2022, which claims the priority benefit of Japan Patent Application No. 2022-057377, filed on Mar. 30, 2022. The entirety of each of the above-mentioned patent applications is hereby incorporated by reference herein and made a part of this specification.

### TECHNICAL FIELD

The present disclosure relates to a vibration isolating and damping member used as a vibration isolating member or a vibration damping member and a manufacturing method thereof, and more particularly to a vibration isolating and damping member formed of foamed polyurethane and a manufacturing method thereof.

### BACKGROUND ART

Vibration isolating and damping members formed of foamed polyurethane include, for example, bumper springs for vehicles. As shown in FIGURE, the bumper spring 2 is a substantially cylindrical (bellows-shaped) structure that is externally inserted onto a piston rod 31 of a shock absorber 30 constituting a suspension of a vehicle, and is used in a state in which it is disposed between a cylinder (an absorber plate) 32 of the shock absorber 30 and a mounting portion (an upper support 33) on the vehicle body side (refer to Patent Literature 1).

The bumper spring is required to have a high energy absorption capacity at high input power and a low energy absorption capacity at low input power in order to achieve both vibration absorption and ride comfort when the vehicle is running or when high power input is applied.

Additionally, in order to achieve an efficient low energy absorption capacity at low input power, generally bumper springs formed of foamed polyurethane containing diphenylmethane diisocyanate (MDI) or the like as an isocyanate component are used.

In addition, heat-crosslinking foamed polyurethane is generally used for members such as the bumper springs which are used in places at which mechanical properties such as high-temperature durability (heat deformation resistance) and flexibility are required (refer to Patent Literature 2).
Japanese Patent No. 3758343
Japanese Patent Laid-Open No. 2004-293697

However, in order to manufacture a vibration isolating and damping member from heat-crosslinking foamed polyurethane, since equipment for casting a material into a mold and heating the material is required, there is a problem that equipment investment becomes large.

Further, since it is difficult to lower the viscosity of the heat-crosslinking foamed polyurethane during injection, there is also a problem that it is difficult to manufacture a vibration isolating and damping member having a complicated shape.

Furthermore, in view of a current situation in which materials that do not burden the global environment are required, there is an increasing need to develop materials for vibration isolating and damping members that are highly recyclable (reusable) and have good mechanical properties.

However, a heat-crosslinking foamed polyurethane is not melted by heat, and thus has poor reusability, which poses a problem in terms of environmental burden.

The present disclosure has been made in view of such circumstances, and provides a vibration isolating and damping member that is excellent in mechanical properties such as high-temperature durability, is excellent in reusability, and is capable of reducing manufacturing costs, and a manufacturing method thereof.

### SUMMARY

The present inventors have made intensive studies in order to solve the above problems. In the course of the studies, the present inventors considered manufacturing a vibration isolating and damping member formed of thermoplastic polyurethane foam. Conventional vibration isolating and damping members using thermosetting polyurethane are softened by heat, but many conventional vibration isolating and damping members contain an excessive amount of isocyanate, and actually, since the cross-linking has progressed to some extent, it is difficult to heat-melt an old vibration isolating and damping member to reuse a vibration isolating and damping member exhibiting the same mechanical properties as before. In addition, since vibration isolating and damping members such as bumper springs generate heat due to high deformation caused by high loads, it has been conventionally thought that thermoplastic urethane cannot be used as a material for such vibration isolating and damping members.

However, as a result of further research conducted by the present inventors based on such common technical knowledge, use of a vibration isolating and damping member formed of a foam of a non-crosslinking thermoplastic urethane composition prepared so that a polyol component was a polyester-based polyol, an isocyanate component was 1,5-naphthalenediisocyanate (NDI), and an NCO index [an equivalence ratio of NCO groups in isocyanate to hydroxyl groups in polyol (NCO groups/OH groups)] was in a range of 0.9 to 1.04 was investigated.

As a result, it has been found that, due to crystallinity of polyester-based polyol and toughness of NDI, the foam becomes excellent in mechanical properties such as high-temperature durability even when the NCO index is set low (in a range of 0.9 to 1.04) as described above, and also the recyclability (the reusability) of the vibration isolating and damping member is improved by making the vibration isolating and damping member be formed of a non-crosslinking thermoplastic urethane composition having a low NCO index.

However, the gist of the present disclosure is the following [1] to [8].
[1] A vibration isolating and damping member is formed of polyurethane, wherein a polyol component of the polyurethane includes a polyester-based polyol excluding a short-chain polyol, an isocyanate component of the polyurethane contains 1,5-naphthalenediisocyanate as a main component, and the vibration isolating and damping member comprises a foam of a thermoplastic urethane composition having an NCO index of 0.9 to 1.04.
[2] In the vibration isolating and damping member described in [1], a proportion of the isocyanate component in the thermoplastic urethane composition may be 10 to 30% by mass.
[3] In the vibration isolating and damping member described in [1] or [2], the polyurethane may have a weight average molecular weight of 50,000 to 500,000.
[4] In the vibration isolating and damping member described in any one of [1] to
[3], the polyester-based polyol may be at least one selected from a group of polyethylene adipate, polycaprolactam, and polycarbonate diol.
[5] In the vibration isolating and damping member described in any one of [1] to
[4], the foam may have a density of 0.3 to 0.8 g/cm³.
[6] In the vibration isolating and damping member described in any one of [1] to
[5], a number average diameter of foam cells in the foam may be 50 to 500 m.
[7] A method of manufacturing the vibration isolating and damping member described in any one of [1] to [6] includes preparing a urethane prepolymer from a polyester-based polyol and an isocyanate component containing 1,5-naphthalenediisocyanate as a main component, mixing the urethane prepolymer with a remaining polyol component to prepare a thermoplastic urethane composition having an NCO index of 0.9 to 1.04, molding a polyurethane foam formed of the thermoplastic urethane composition, and separating the polyurethane foam from a molding die.
[8] In the method described in [7], the molding of the polyurethane foam formed of the thermoplastic urethane composition may be defined as pelletizing the thermoplastic urethane composition temporarily, melting pellets with an injection molding machine, and casting the pellets in a foamed state into a molding die to mold a polyurethane foam.

### BRIEF DESCRIPTION OF DRAWINGS

FIGURE an explanatory view showing an embodiment of a urethane bumper spring.

### DESCRIPTION OF EMBODIMENTS

As described above, the vibration isolating and damping member of the present disclosure is excellent in mechanical properties such as high-temperature durability, is excellent in reusability, and can reduce manufacturing costs.

Next, an embodiment of the present disclosure will be described in detail. However, the present disclosure is not limited to this embodiment.

In the present disclosure, when expressing with “X to Y” (X and Y are arbitrary numbers), unless otherwise specified, the meaning of “preferably greater than X” or “preferably smaller than Y” is included together with the meaning of “X or more and Y or less.”

In addition, when expressing with “X or more” (X is an arbitrary number) or “Y or less” (Y is an arbitrary number), the intent of “preferably greater than X” or “preferably less than Y” is also encompassed.

A vibration isolating and damping member of the present disclosure (hereinafter referred to as “this vibration isolating and damping member”) is formed of polyurethane, and is formed of a foam of a thermoplastic urethane composition in which a polyol component of the polyurethane includes a polyester-based polyol excluding short-chain polyols, an isocyanate component of the polyurethane includes 1,5-naphthalenediisocyanate as a main component, and an NCO index is 0.9 to 1.04.

The “main component” means that 70% by mass or more, preferably 80% by mass or more, and more preferably 95 to 100% by mass of the isocyanate component is 1,5-naphthalenediisocyanate.

In addition, the above-described “the polyol component of the polyurethane includes a polyester-based polyol excluding short-chain polyols” does not mean that short-chain polyols are not used as the polyol component of the polyurethane, but is intended to mean that only polyester-based polyols are used other than short-chain polyols as the polyol component used in the polyurethane. Here, short-chain polyols mean a polyol having a number average molecular weight (Mn) of 500 or less.

The constituent components of the thermoplastic urethane composition will be described in detail below.

[Polyol Component]

In the thermoplastic urethane composition, only polyester-based polyol is used as the polyol component excluding short-chain polyol.

Examples of the polyester-based polyol include polyethylene adipate, polypropanediol adipate, polybutanediol adipate, polypentanediol adipate, polyhexanediol adipate, polyheptanediol adipate, polyoctanediol adipate, polynonanediol adipate, polydecanediol adipate, polydodecanediol adipate, polycaprolactam, polylauryllactam, polylaurolactam, polycarbonate diol, and the like. They are used alone or in combination of two or more. Among them, polyethylene adipate, polycaprolactam, and polycarbonate diol are preferable because of their excellent heat resistance.

The polyester-based polyol preferably has a number average molecular weight (Mn) of 1,000 to 4,000, more preferably 1,250 to 3,000, and even more preferably 1,500 to 2,500.

That is, it is possible to produce a thermoplastic urethane having a target molecular weight and molecular structure using the polyester-based polyol having such a molecular weight. The number average molecular weight (Mn) can be determined by a gel permeation chromatography (GPC) method or the like.

A proportion of the polyester-based polyol in the thermoplastic urethane composition is preferably 50 to 90% by mass, more preferably 55 to 88% by mass, and even more preferably 60 to 85% by mass.

Moreover, in the thermoplastic urethane composition, a short-chain polyol can be used as needed. Examples of such short-chain polyol include 1,4-butanediol, ethylene glycol, 1,3-propanediol, 1,5-pentanediol, 1,6-hexanediol, 1,7-heptanediol, 1,8-octanediol, 1,9-nonanediol, 1,10-decanediol, 1,12-dodecanediol, and the like. They are used alone or in combination of two or more. Among them, 1,4-butanediol is preferable because of excellent fluidity thereof.

The proportion of the short-chain polyol in the thermoplastic urethane composition is preferably 0.1 to 20% by mass, more preferably 0.3 to 15% by mass, and even more preferably 0.5 to 12% by mass.

[Isocyanate Component]

In the thermoplastic urethane composition, as the isocyanate component, one containing 1,5-naphthalenediisocyanate (NDI) as a main component is used, and preferably only NDI is used.

When other isocyanate components are used together with NDI, for example, aromatic diisocyanates such as 4,4′-diphenylmethane diisocyanate, tolylene diisocyanate and phenylene diisocyanate, and aliphatic diisocyanates such as 1,2-ethylene diisocyanate, 1,3-propylene diisocyanate, 1,4-butane diisocyanate, 1,6-hexamethylene diisocyanate, 1,4-cyclohexane diisocyanate, 1,3-cyclohexane diisocyanate, isophorone diisocyanate and hydrogenated 4,4′-phenylmethane diisocyanate may be used alone or in combination of two or more.

The proportion of the isocyanate component in the thermoplastic urethane composition is preferably 10 to 30% by mass, more preferably 12 to 28% by mass, and even more preferably 14 to 22% by mass. Then, an NCO index [an equivalence ratio of NCO groups in the isocyanate to hydroxyl groups in the polyol (NCO groups/OH groups)] in the thermoplastic urethane composition is in a range of 0.9 to 1.04, preferably 0.9 to 1.0, and more preferably 0.95 to 1.0.

That is, a good foaming state can be achieved by defining in this way, and both high-temperature durability and reusability can be satisfactorily achieved.

[Other Components]

If necessary, the thermoplastic urethane composition may contain a foaming agent, a chain extender, a catalyst, a foam stabilizer, a hydrolysis inhibitor, a flame retardant, a viscosity reducing agent, a stabilizer, a filler, a colorant, and the like, in addition to the polyol component and the isocyanate component.

Examples of the foaming agent include sodium bicarbonate, an azo compound such as azodicarbonamide, an azide compound such as p-toluenesulfonyl azide, and a nitroso compound such as N,N′-dinitrosopentamethylenetetramine.

In the present disclosure, since the thermoplastic urethane composition is non-crosslinkable, it does not contain crosslinkers (including those that contribute to crosslinkage).

Then, preferably, after a urethane prepolymer is prepared from some (or all) of the polyester-based polyol and the isocyanate component containing 1,5-naphthalenediisocyanate as a main component, a thermoplastic urethane composition having an NCO index of 0.9 to 1.04 is prepared by mixing the urethane prepolymer and the remaining polyol component (the remainder of the polyester-based polyol, or the short-chain polyol), and thus a good foaming state can be realized, and a non-crosslinking thermoplastic urethane composition that satisfactorily achieves both high-temperature durability and reusability can be obtained.

The above preparation work is preferably carried out at an ambient temperature of 80 to 120° C. Moreover, when other components are blended in, it is preferable to add them at the stage of mixing the urethane prepolymer and the remaining polyol component.

As a method of preparing the urethane composition, either a one-shot method in which a long-chain polyol, a short-chain glycol as a chain extender, and a diisocyanate are simultaneously polymerized or a prepolymer method in which a long-chain polyol and a diisocyanate are pre-reacted to synthesize a prepolymer, and then a short-chain glycol is added and polymerized may be used. As a manufacturing method, any of a batch method, a band casting method, and a reactive extrusion method may be used.

A weight average molecular weight (Mw) of the polyurethane in the thermoplastic urethane composition is preferably 50,000 to 500,000, more preferably 75,000 to 400,000, and even more preferably 100,000 to 300,000. With such a weight average molecular weight, a good foaming state can be realized, and a non-crosslinking thermoplastic urethane composition that satisfactorily achieves both high-temperature durability and reusability can be obtained. The weight average molecular weight of the polyurethane can be determined by a gel permeation chromatography (GPC) method or the like.

Here, for example, a high-speed GPC apparatus (HLC-8320GPC manufactured by Tosoh Corporation) is used as a measuring instrument in the GPC method. Then, the relationship between a known weight average molecular weight and an elution time from a standard sample is obtained in advance, and a calibration curve from which the weight average molecular weight can be obtained from the elution time is created. Next, the elution time of polyurethane is measured using the following apparatus and operating conditions, and the weight average molecular weight (converted to polystyrene) is calculated with reference to the calibration curve.

<Apparatus and Operating Conditions>
Separation column: TSKgelSuperAWM-H (used by connecting two in series) manufactured by Tosoh Corporation
Detector: Differential Refractometer
Column temperature: 40° C.
Mobile phase: N,N-dimethylformamide (10 mmol/L LiBr) manufactured by Kanto Chemical Co., Ltd.
Standard sample: standard polystyrene kit (PStQuick B manufactured by Tosoh Corporation)
Sample concentration: 0.1% by mass
Sample injection volume: 30 μL
Flow rate: 0.5 mL/min

If necessary, the thermoplastic urethane composition prepared as described above is temporarily pelletized, and then the pellets are injected and cast into a molding die (a mold and the like) in a melted and foamed state by an injection molding machine.

The thermoplastic urethane composition may be cast into a molding die in a melted and foamed state without being pelletized.

In order to bring the thermoplastic urethane composition into the melted and foamed state as described above, for example, in addition to adding a foaming agent in advance to the thermoplastic urethane composition, it can be realized by a mode in which a foaming agent is added when the thermoplastic urethane composition is melted, or the foaming agent is dry blended with the pellets and melted, or a mode in which the thermoplastic urethane composition is physically foamed by blowing carbon dioxide gas or nitrogen gas when the thermoplastic urethane composition is melted.

The melting of the thermoplastic urethane composition is performed at 150 to 290° C. using a molding machine such as an injection molding machine.

After the thermoplastic urethane composition is cast into a molding die in a melted and foamed state as described above, a polyurethane foam formed of the thermoplastic urethane composition can be molded.

Then, this desired vibration isolating and damping member can be obtained by separating the polyurethane foam from the molding die.

In this vibration isolating and damping member obtained in this way, a density thereof is preferably 0.3 to 0.8 g/cm³, more preferably 0.4 to 0.8 g/cm³, and even more preferably 0.5 to 0.6 g/cm³. Excellent mechanical properties such as high-temperature durability (heat deformation resistance) and flexibility can be obtained by setting such a density.

The density can be measured, for example, by an automatic hydrometer DSG-1 manufactured by Toyo Seiki Co., Ltd.

The number average diameter of foam cells in this vibration isolating and damping member is preferably 50 to 500 m, and more preferably 100 to 300 m. Excellent mechanical properties such as high-temperature durability (resistance to heat deformation) and flexibility can be obtained by setting the number average diameter of the foam cells in such a manner.

The number average diameter of the foam cells is obtained by creating a measurement sample of 2 mm² from this vibration isolating and damping member, measuring 50 foam cell diameters in a field of view of 1 mm² using a scanning electron microscope (SEM), and finding an average thereof.

Since this vibration isolating and damping member has high reusability, for example, it is possible to heat-melt an old vibration isolating and damping member to reuse as a vibration isolating and damping member exhibiting the same mechanical properties as before, or to recycle it into another material.

Additionally, this vibration isolating and damping member is suitable for applications in which high-temperature durability (heat deformation resistance) is required, and can be suitably applied to various vibration isolating and damping members such as engine mounts for automobiles, transmission mounts, body mounts, cab mounts, member mounts, connecting rods, torque rods, strut bar cushions, center bearing supports, torsional dampers, steering rubber couplings, tension rod bushes, bushes, bound stoppers, FF engine roll stoppers, and muffler hangers, in addition to bumper springs mounted in piston rods of shock absorbers.

### EXAMPLES

Next, examples will be described together with comparative examples. However, the present disclosure is not limited to these Examples as long as the gist thereof is not exceeded.

First, prior to Examples and Comparative Examples, the following materials were prepared.

[PEA]

Polyethylene adipate with a number average molecular weight of 2000 (POLYLITE OD-X-2610, manufactured by DIC)

[PCL]

Polycaprolactam with a number average molecular weight of 2000 (POLYLITE OD-X-640 manufactured by DIC)

[NDI]

1,5-naphthalene diisocyanate (manufactured by Tokyo Chemical Industry Co., Ltd.)

[Short-Chain Polyol]

1,4-butanediol (manufactured by Tokyo Chemical Industry Co., Ltd.)

[Foam Stabilizer]

NIAX silicone L-5388 (manufactured by Momentive Performance Materials)

[Catalyst]

N,N-dimethylcyclohexylamine (manufactured by Tokyo Chemical Industry Co., Ltd.)

[Hydrolysis Inhibitor]

Stavacsol I (manufactured by Rhein Chemie Corporation)

### Example 1

56% by mass of PEA as the polyol component and 14% by mass of NDI as the isocyanate component were mixed at a liquid temperature of 130° C. to prepare a urethane prepolymer. Next, the urethane prepolymer, 26% by mass of the same new material as the PEA, 2.5% by mass of a short-chain polyol, 0.03% by mass of a foam stabilizer, 0.03% by mass of a catalyst, and 1.44% by mass of a hydrolysis inhibitor were mixed at a liquid temperature of 100° C. to prepare a urethane composition having an NCO index of 1.00.

A weight average molecular weight (Mw) of the polyurethane in the urethane composition was 200,000 as a result of measurement using a high-speed GPC apparatus (HLC-8320GPC manufactured by Tosoh Corporation) under the conditions described above.

Next, the urethane composition was pelletized by a uniaxial high-speed crusher (PSF-40 manufactured by Tani Kogyo Co., Ltd.), then the pellets were melted at 200° C. with an injection molding machine (J110AD-180H manufactured by Japan Steel Works, Ltd.), nitrogen gas was added under the conditions of a gas injection amount of 0.26 g to form a foamed state, and then injection molding was performed in a molding die. Then, a polyurethane molded product (a sample) was obtained by being separated from the molding die.

A measurement sample of 2 mm² was created from the sample, and as a result of measuring 50 foam cell diameters in a field of view of 1 mm² using a scanning electron microscope (SEM) and averaging them, the foam cell diameter (the number average diameter of foam cells) was 100 m.

Further, a density of the measurement sample was measured with an automatic hydrometer DSG-1 manufactured by Toyo Seiki Co., Ltd., and the density was 0.5 g/cm³.

### Example 2

54% by mass of PEA as the polyol component and 13% by mass of NDI as the isocyanate component were mixed at a liquid temperature of 130° C. to prepare a urethane prepolymer. Next, the urethane prepolymer, 29% by mass of the same new material as the PEA, and 2.5% by mass of a short-chain polyol, 0.03% by mass of a foam stabilizer, 0.03% by mass of a catalyst, and 1.44% by mass of a hydrolysis inhibitor are mixed at a liquid temperature of 100° C. to prepare a urethane composition having an NCO index of 0.90.

A weight average molecular weight (Mw) of the polyurethane in the urethane composition was 180,000 as a result of measurement using a high-speed GPC apparatus (HLC-8320GPC manufactured by Tosoh Corporation) under the conditions described above.

Next, the urethane composition was pelletized by a uniaxial high-speed crusher (PSF-40 manufactured by Tani Kogyo Co., Ltd.), then the pellets were melted at 200° C. with an injection molding machine (J110AD-180H manufactured by Japan Steel Works, Ltd.), nitrogen gas was added under the conditions of a gas injection amount of 0.26 g to form a foamed state, and then injection molding was performed in a molding die. Then, a polyurethane molded product (a sample) was obtained by being separated from the molding die.

A measurement sample of 2 mm² was created from the sample, and as a result of measuring 50 foam cell diameters in a field of view of 1 mm² using a scanning electron microscope (SEM) and averaging them, the foam cell diameter (the number average diameter of foam cells) was 110 m.

Further, a density of the measurement sample was measured with an automatic hydrometer DSG-1 manufactured by Toyo Seiki Co., Ltd., and the density was 0.5 g/cm³.

### Example 3

57% by mass of PEA as the polyol component and 15% by mass of NDI as the isocyanate component were mixed at a liquid temperature of 130° C. to prepare a urethane prepolymer. Next, the urethane prepolymer, 24% by mass of the same new material as the PEA, 2.5% by mass of a short-chain polyol, 0.03% by mass of a foam stabilizer, 0.03% by mass of a catalyst, and 1.44% by mass of a hydrolysis inhibitor were mixed at a liquid temperature of 100° C. to prepare a urethane composition having an NCO index of 1.04.

A weight average molecular weight (Mw) of the polyurethane in the urethane composition was 180,000 as a result of measurement using a high-speed GPC apparatus (HLC-8320GPC manufactured by Tosoh Corporation) under the conditions described above.

Next, the urethane composition was pelletized by a uniaxial high-speed crusher (PSF-40 manufactured by Tani Kogyo Co., Ltd.), then, the pellets were melted at 200° C. with an injection molding machine (J110AD-180H manufactured by Japan Steel Works, Ltd.), nitrogen gas was added under the conditions of a gas injection amount of 0.26 g to form a foamed state, and then injection molding was performed in a molding die. Then, a polyurethane molded product (a sample) was obtained by being separated from the molding die.

A measurement sample of 2 mm² was created from the sample, and as a result of measuring 50 foam cell diameters in a field of view of 1 mm² using a scanning electron microscope (SEM) and averaging them, the foam cell diameter (the number average diameter of foam cells) was 90 m.

Further, a density of the measurement sample was measured with an automatic hydrometer DSG-1 manufactured by Toyo Seiki Co., Ltd., and the density was 0.5 g/cm³.

### Example 4

40% by mass of PEA as the polyol component and 10% by mass of NDI as the isocyanate component were mixed at a liquid temperature of 130° C. to prepare a urethane prepolymer. Next, the urethane prepolymer, 47% by mass of the same new material as the PEA, and 0.5% by mass of a short-chain polyol, 0.03% by mass of a foam stabilizer, 0.03% by mass of a catalyst, and 20.44% by mass of a hydrolysis inhibitor are mixed at a liquid temperature of 100° C. to prepare a urethane composition having an NCO index of 1.00.

A weight average molecular weight (Mw) of the polyurethane in the urethane composition was 300,000 as a result of measurement using a high-speed GPC apparatus (HLC-8320GPC manufactured by Tosoh Corporation) under the conditions described above.

Next, the urethane composition was pelletized by a uniaxial high-speed crusher (PSF-40 manufactured by Tani Kogyo Co., Ltd.), then, the pellets were melted at 200° C. with an injection molding machine (J110AD-180H manufactured by Japan Steel Works, Ltd.), nitrogen gas was added under the conditions of a gas injection amount of 0.26 g to form a foamed state, and then injection molding was performed in a molding die. Then, a polyurethane molded product (a sample) was obtained by being separated from the molding die.

A measurement sample of 2 mm² was created from the sample, and as a result of measuring 50 foam cell diameters in a field of view of 1 mm² using a scanning electron microscope (SEM) and averaging them, the foam cell diameter (the number average diameter of foam cells) was 100 m.

Further, a density of the measurement sample was measured with an automatic hydrometer DSG-1 manufactured by Toyo Seiki Co., Ltd., and the density was 0.5 g/cm³.

### Example 5

59% by mass of PEA as the polyol component and 30% by mass of NDI as the isocyanate component were mixed at a liquid temperature of 130° C. to prepare a urethane prepolymer. Next, 10.5% by mass of a short-chain polyol, 0.03% by mass of a foam stabilizer, 0.03% by mass of a catalyst, and 0.44% by mass of a hydrolysis inhibitor were mixed at a liquid temperature of 100° C. to prepare a urethane composition having an NCO index of 1.00.

A weight average molecular weight (Mw) of the polyurethane in the urethane composition was 300,000 as a result of measurement using a high-speed GPC apparatus (HLC-8320GPC manufactured by Tosoh Corporation) under the conditions described above.

Next, the urethane composition was pelletized by a uniaxial high-speed crusher (PSF-40 manufactured by Tani Kogyo Co., Ltd.), then, the pellets were melted at 200° C. by an injection molding machine (J110AD-180H manufactured by Japan Steel Works, Ltd.), nitrogen gas was added under the conditions of a gas injection amount of 0.26 g to form a foamed state, and then injection molding was performed in a molding die. Then, a polyurethane molded product (a sample) was obtained by being separated from the molding die.

A measurement sample of 2 mm² was created from the sample, and as a result of measuring 50 foam cell diameters in a field of view of 1 mm² using a scanning electron microscope (SEM) and averaging them, the foam cell diameter (the number average diameter of foam cells) was 110 m.

Further, a density of the measurement sample was measured with an automatic hydrometer DSG-1 manufactured by Toyo Seiki Co., Ltd., and the density was 0.5 g/cm³.

### Example 6

56% by mass of PEA as the polyol component and 14% by mass of NDI as the isocyanate component were mixed at a liquid temperature of 130° C. to prepare a urethane prepolymer. Next, the urethane prepolymer, 26% by mass of the same new material as the PEA, and 2.5% by mass of a short-chain polyol, 0.03% by mass of a foam stabilizer, 0.03% by mass of a catalyst, and 1.44% by mass of a hydrolysis inhibitor are mixed at a liquid temperature of 100° C. to prepare a urethane composition having an NCO index of 1.00.

A weight average molecular weight (Mw) of the polyurethane in the urethane composition was 50,000 as a result of measurement using a high-speed GPC apparatus (HLC-8320GPC manufactured by Tosoh Corporation) under the conditions described above.

Next, the urethane composition was pelletized by a uniaxial high-speed crusher (PSF-40 manufactured by Tani Kogyo Co., Ltd.), then, the pellets were melted at 200° C. by an injection molding machine (J110AD-180H manufactured by Japan Steel Works, Ltd.), nitrogen gas was added under the conditions of a gas injection amount of 0.26 g to form a foamed state, and then injection molding was performed in a molding die. Then, a polyurethane molded product (a sample) was obtained by being separated from the molding die.

A measurement sample of 2 mm² was created from the sample, and as a result of measuring 50 foam cell diameters in a field of view of 1 mm² using a scanning electron microscope (SEM) and averaging them, the foam cell diameter (the number average diameter of foam cells) was 90 m.

Further, a density of the measurement sample was measured with an automatic hydrometer DSG-1 manufactured by Toyo Seiki Co., Ltd., and the density was 0.5 g/cm³.

### Example 7

56% by mass of PEA as the polyol component and 14% by mass of NDI as the isocyanate component were mixed at a liquid temperature of 130° C. to prepare a urethane prepolymer. Next, the urethane prepolymer, 26% by mass of the same new material as the PEA, 2.5% by mass of a short-chain polyol, 0.03% by mass of a foam stabilizer, 0.03% by mass of a catalyst, and 1.44% by mass of a hydrolysis inhibitor are mixed at a liquid temperature of 100° C. to prepare a urethane composition having an NCO index of 1.00.

A weight average molecular weight (Mw) of the polyurethane in the urethane composition was 500,000 as a result of measurement using a high-speed GPC apparatus (HLC-8320GPC manufactured by Tosoh Corporation) under the conditions described above.

Next, the urethane composition was pelletized by a uniaxial high-speed crusher (PSF-40 manufactured by Tani Kogyo Co., Ltd.), then, the pellets were melted at 200° C. by an injection molding machine (J110AD-180H manufactured by Japan Steel Works, Ltd.), nitrogen gas was added under the conditions of a gas injection amount of 0.26 g to form a foamed state, and then injection molding was performed in a molding die. Then, a polyurethane molded product (a sample) was obtained by being separated from the molding die.

A measurement sample of 2 mm² was created from the sample, and as a result of measuring 50 foam cell diameters in a field of view of 1 mm² using a scanning electron microscope (SEM) and averaging them, the foam cell diameter (the number average diameter of foam cells) was 100 m.

Further, a density of the measurement sample was measured with an automatic hydrometer DSG-1 manufactured by Toyo Seiki Co., Ltd., and the density was 0.5 g/cm³.

### Example 8

56% by mass of PCL as a polyol component and 14% by mass of NDI as the isocyanate component were mixed at a liquid temperature of 130° C. to prepare a urethane prepolymer. Next, the urethane prepolymer, 26% by mass of the same new material as the PCL, 2.5% by mass of a short-chain polyol, 0.03% by mass of a foam stabilizer, 0.03% by mass of a catalyst, and 1.44% by mass of a hydrolysis inhibitor are mixed at a liquid temperature of 100° C. to prepare a urethane composition having an NCO index of 1.00.

A weight average molecular weight (Mw) of the polyurethane in the urethane composition was 100,000 as a result of measurement using a high-speed GPC apparatus (HLC-8320GPC manufactured by Tosoh Corporation) under the conditions described above.

Next, the urethane composition was pelletized by a uniaxial high-speed crusher (PSF-40 manufactured by Tani Kogyo Co., Ltd.), then, the pellets were melted at 200° C. by an injection molding machine (J110AD-180H manufactured by Japan Steel Works, Ltd.), nitrogen gas was added under the conditions of a gas injection amount of 0.26 g to form a foamed state, and then injection molding was performed in a molding die. Then, a polyurethane molded product (a sample) was obtained by being separated from the molding die.

A measurement sample of 2 mm² was created from the sample, and as a result of measuring 50 foam cell diameters in a field of view of 1 mm² using a scanning electron microscope (SEM) and averaging them, the foam cell diameter (the number average diameter of foam cells) was 110 m.

Further, a density of the measurement sample was measured with an automatic hydrometer DSG-1 manufactured by Toyo Seiki Co., Ltd., and the density was 0.5 g/cm³.

### Example 9

56% by mass of PEA as the polyol component and 14% by mass of NDI as the isocyanate component were mixed at a liquid temperature of 130° C. to prepare a urethane prepolymer. Next, the urethane prepolymer, 26% by mass of the same new material as the PEA, 2.5% by mass of a short-chain polyol, 0.03% by mass of a foam stabilizer, 0.03% by mass of a catalyst, and 1.44% by mass of a hydrolysis inhibitor are mixed at a liquid temperature of 100° C. to prepare a urethane composition having an NCO index of 1.00.

A weight average molecular weight (Mw) of the polyurethane in the urethane composition was 200,000 as a result of measurement using a high-speed GPC apparatus (HLC-8320GPC manufactured by Tosoh Corporation) under the conditions described above.

Next, the urethane composition was pelletized by a uniaxial high-speed crusher (PSF-40 manufactured by Tani Kogyo Co., Ltd.), Then, the pellets were melted at 200° C. with an injection molding machine (J110AD-180H manufactured by Japan Steel Works, Ltd.), nitrogen gas was added under the conditions of a gas injection amount of 0.32 g to form a foamed state, and then injection molding was performed in a molding die. Then, a polyurethane molded product (a sample) was obtained by being separated from the molding die.

A measurement sample of 2 mm² was created from the sample, and as a result of measuring 50 foam cell diameters in a field of view of 1 mm² using a scanning electron microscope (SEM) and averaging them, the foam cell diameter (the number average diameter of foam cells) was 50 μm.

Further, a density of the measurement sample was measured with an automatic hydrometer DSG-1 manufactured by Toyo Seiki Co., Ltd., and the density was 0.5 g/cm³.

### Example 10

56% by mass of PEA as the polyol component and 14% by mass of NDI as the isocyanate component were mixed at an ambient temperature of 127° C. to prepare a urethane prepolymer. Next, the urethane prepolymer, 26% by mass of the same new material as the PEA, 2.5% by mass of a short-chain polyol, 0.03% by mass of a foam stabilizer, 0.03% by mass of a catalyst, and 1.44% by mass of a hydrolysis inhibitor are mixed at a liquid temperature of 100° C. to prepare a urethane composition having an NCO index of 1.00.

A weight average molecular weight (Mw) of the polyurethane in the urethane composition was 200,000 as a result of measurement using a high-speed GPC apparatus (HLC-8320GPC manufactured by Tosoh Corporation) under the conditions described above.

Next, the urethane composition was pelletized by a uniaxial high-speed crusher (PSF-40 manufactured by Tani Kogyo Co., Ltd.), then, the pellets were melted at 200° C. with an injection molding machine (J110AD-180H manufactured by Japan Steel Works, Ltd.), nitrogen gas was added under the conditions of a gas injection amount of 0.2 g to form a foamed state, and then injection molding was performed in a molding die. Then, a polyurethane molded product (a sample) was obtained by being separated from the molding die.

A measurement sample of 2 mm² was created from the sample, and as a result of measuring 50 foam cell diameters in a field of view of 1 mm² using a scanning electron microscope (SEM) and averaging them, the foam cell diameter (the number average diameter of foam cells) was 500 μm.

Further, a density of the measurement sample was measured with an automatic hydrometer DSG-1 manufactured by Toyo Seiki Co., Ltd., and the density was 0.5 g/cm³.

### Example 11

56% by mass of PEA as the polyol component and 14% by mass of NDI as the isocyanate component were mixed at a liquid temperature of 130° C. to prepare a urethane prepolymer. Next, the urethane prepolymer, 26% by mass of the same new material as the PEA, 2.5% by mass of a short-chain polyol, 0.03% by mass of a foam stabilizer, 0.03% by mass of a catalyst, and 1.44% by mass of a hydrolysis inhibitor are mixed at a liquid temperature of 100° C. to prepare a urethane composition having an NCO index of 1.00.

A weight average molecular weight (Mw) of the polyurethane in the urethane composition was 200,000 as a result of measurement using a high-speed GPC apparatus (HLC-8320GPC manufactured by Tosoh Corporation) under the conditions described above.

Next, the urethane composition was pelletized by a uniaxial high-speed crusher (PSF-40 manufactured by Tani Kogyo Co., Ltd.), then, the pellets were melted at 200° C. with an injection molding machine (J110AD-180H manufactured by Japan Steel Works, Ltd.), nitrogen gas was added under the conditions of a gas injection amount of 0.32 g to form a foamed state, and then injection molding was performed in a molding die. Then, a polyurethane molded product (a sample) was obtained by being separated from the molding die.

A measurement sample of 2 mm² was created from the sample, and as a result of measuring 50 foam cell diameters in a field of view of 1 mm² using a scanning electron microscope (SEM) and averaging them, the foam cell diameter (the number average diameter of foam cells) was 90 km.

Further, a density of the measurement sample was measured with an automatic hydrometer DSG-1 manufactured by Toyo Seiki Co., Ltd., and the density was 0.3 g/cm³.

### Example 12

56% by mass of PEA as the polyol component and 14% by mass of NDI as the isocyanate component were mixed at a liquid temperature of 130° C. to prepare a urethane prepolymer. Next, the urethane prepolymer, 26% by mass of the same new material as the PEA, 2.5% by mass of a short-chain polyol, 0.03% by mass of a foam stabilizer, 0.03% by mass of a catalyst, and 1.44% by mass of a hydrolysis inhibitor are mixed at a liquid temperature of 100° C. to prepare a urethane composition having an NCO index of 1.00.

A weight average molecular weight (Mw) of the polyurethane in the urethane composition was 200,000 as a result of measurement using a high-speed GPC apparatus (HLC-8320GPC manufactured by Tosoh Corporation) under the conditions described above.

Next, the urethane composition was pelletized by a uniaxial high-speed crusher (PSF-40 manufactured by Tani Kogyo Co., Ltd.), then, the pellets were melted at 200° C. with an injection molding machine (J110AD-180H manufactured by Japan Steel Works, Ltd.), nitrogen gas was added under the conditions of a gas injection amount of 0.2 g to form a foamed state, and then injection molding was performed in a molding die. Then, a polyurethane molded product (a sample) was obtained by being separated from the molding die.

A measurement sample of 2 mm² was created from the sample, and as a result of measuring 50 foam cell diameters in a field of view of 1 mm² using a scanning electron microscope (SEM) and averaging them, the foam cell diameter (the number average diameter of foam cells) was 110 m.

Further, a density of the measurement sample was measured with an automatic hydrometer DSG-1 manufactured by Toyo Seiki Co., Ltd., and the density was 0.8 g/cm³.

### Comparative Example 1

54% by mass of PEA as the polyol component and 13% by mass of NDI as the isocyanate component were mixed at a liquid temperature of 130° C. to prepare a urethane prepolymer. Next, the urethane prepolymer, 29% by mass of the same new material as the PEA, 2.5% by mass of a short-chain polyol, 0.03% by mass of a foam stabilizer, 0.03% by mass of a catalyst, and 1.44% by mass of a hydrolysis inhibitor are mixed at a liquid temperature of 100° C. to prepare a urethane composition having an NCO index of 0.87.

A weight average molecular weight (Mw) of the polyurethane in the urethane composition was 100,000 as a result of measurement using a high-speed GPC apparatus (HLC-8320GPC manufactured by Tosoh Corporation) under the conditions described above.

Next, the urethane composition was pelletized by a uniaxial high-speed crusher (PSF-40 manufactured by Tani Kogyo Co., Ltd.), then, the pellets were melted at 200° C. with an injection molding machine (J110AD-180H manufactured by Japan Steel Works, Ltd.), nitrogen gas was added under the conditions of a gas injection amount of 0.26 g to form a foamed state, and then injection molding was performed in a molding die. Then, a polyurethane molded product (a sample) was obtained by being separated from the molding die.

A measurement sample of 2 mm2 was created from the sample, and as a result of measuring 50 foam cell diameters in a field of view of 1 mm² using a scanning electron microscope (SEM) and averaging them, the foam cell diameter (the number average diameter of foam cells) was 90 m.

Further, a density of the measurement sample was measured with an automatic hydrometer DSG-1 manufactured by Toyo Seiki Co., Ltd., and the density was 0.5 g/cm³.

### Comparative Example 2

60% by mass of PEA as the polyol component and 15% by mass of NDI as the isocyanate component were mixed at a liquid temperature of 130° C. to prepare a urethane prepolymer. Next, the urethane prepolymer, 21% by mass of the same new material as the PEA, and 2.6% by mass of a short-chain polyol, 0.03% by mass of a foam stabilizer, 0.03% by mass of a catalyst, and 1.34% by mass of a hydrolysis inhibitor are mixed at a liquid temperature of 100° C. to prepare a urethane composition having an NCO index of 1.05.

A weight average molecular weight (Mw) of the polyurethane in the urethane composition was 100,000 as a result of measurement using a high-speed GPC apparatus (HLC-8320GPC manufactured by Tosoh Corporation) under the conditions described above.

Next, the urethane composition was pelletized by a uniaxial high-speed crusher (PSF-40 manufactured by Tani Kogyo Co., Ltd.), then, the pellets were melted at 200° C. with an injection molding machine (J110AD-180H manufactured by Japan Steel Works, Ltd.), nitrogen gas was added under the conditions of a gas injection amount of 0.26 g to form a foamed state, and then injection molding was performed in a molding die. Then, a polyurethane molded product (a sample) was obtained by being separated from the molding die.

A measurement sample of 2 mm² was created from the sample, and as a result of measuring 50 foam cell diameters in a field of view of 1 mm² using a scanning electron microscope (SEM) and averaging them, the foam cell diameter (the number average diameter of foam cells) was 110 m.

Further, a density of the measurement sample was measured with an automatic hydrometer DSG-1 manufactured by Toyo Seiki Co., Ltd., and the density was 0.5 g/cm³.

### Comparative Example 3

56% by mass of PEA as the polyol component and 14% by mass of NDI as the isocyanate component were mixed at a liquid temperature of 130° C. to prepare a urethane prepolymer. Next, the urethane prepolymer, 26% by mass of the same new material as the PEA, 2.5% by mass of a short-chain polyol, 0.03% by mass of a foam stabilizer, 0.03% by mass of a catalyst, and 1.44% by mass of a hydrolysis inhibitor are mixed at a liquid temperature of 100° C. to prepare a urethane composition having an NCO index of 1.00.

A weight average molecular weight (Mw) of the polyurethane in the urethane composition was 300,000 as a result of measurement using a high-speed GPC apparatus (HLC-8320GPC manufactured by Tosoh Corporation) under the conditions described above.

Next, the urethane composition was pelletized by a uniaxial high-speed crusher (PSF-40 manufactured by Tani Kogyo Co., Ltd.), then, the pellets were melted at 200° C. by an injection molding machine (J110AD-180H manufactured by Japan Steel Works, Ltd.) and were injection-molded into a molding die in a non-foamed state. Then, a polyurethane molded product (a sample) was obtained by being separated from the molding die.

A measurement sample of 2 mm² was created from the above sample and observed using a scanning electron microscope (SEM), but no foam cells were found.

Further, a density of the measurement sample was measured with an automatic hydrometer DSG-1 manufactured by Toyo Seiki Co., Ltd., and the density was 1 g/cm³.

Next, with respect to the polyurethane molded products (the samples of the vibration isolating and damping members) of Examples and Comparative Examples obtained as described above, each property was measured and evaluated according to the following criteria. The results thereof are also shown in Table 1 below.

<Reusability>

A state when 2 g of pellets obtained by cutting the polyurethane molded product were heated in an oven at 200° C. for 15 minutes was visually evaluated according to the following criteria, and thus the reusability is evaluated.
[symbol] (excellent): The pellets melted and flowed 1.5 times or more an area on which the pellets were placed.
O (very good): The pellets melted and flowed less than 1.5 times the area on which the pellets were placed.
X (poor): The pellets did not melt.

<High-Temperature Durability>

A cylindrical sample with a diameter of 29 mm and a height of 12 mm was created from the polyurethane molded product, and was repeatedly compressed 100 times at 7000 N in an atmosphere of 80° C., and then a height reduction rate (a deformation) of the sample was measured, and the high-temperature durability was evaluated according to the following criteria.
[symbol] (excellent): The height reduction rate (deformation) of the sample is less than 20%.
O (very good): The height reduction rate (deformation) of the sample is 20% or more and less than 40%.
X (poor): The height reduction rate (deformation) of the sample is 40% or more.

<Flexibility>

A cylindrical sample of φ29 mm×height 12 mm was created from the polyurethane molded product, and hardness was measured using an A-type hardness tester in an atmosphere of 23° C., and flexibility was evaluated according to the following criteria.
O (very good): HA hardness of the sample is less than 95.
X (poor): HA hardness of sample is 95 or more.

TABLE 1

| | | Example | | | | | | | |
|---|---|---|---|---|---|---|---|---|---|
| Polyol | Kind | PEA | PEA | PEA | PEA | PEA | PEA | PEA | PEA |
| component | Proportion | 82 | 83 | 81 | 87 | 59 | 82 | 82 | 82 |
| | (wt %) | | | | | | | | |
| Isocyanate | Kind | NDI | NDI | NDI | NDI | NDI | NDI | NDI | NDI |
| component | Proportion | 14 | 13 | 15 | 10 | 30 | 14 | 14 | 14 |
| | (wt %) | | | | | | | | |

| | | | | | | | | |
|---|---|---|---|---|---|---|---|---|
| Proportion of short- | 2.5 | 2.5 | 2.5 | 0.5 | 10.5 | 2.5 | 2.5 | 2.5 |
| chain polyol (wt %) | | | | | | | | |
| NCO index (NCO/OH) | 1.00 | 0.90 | 1.04 | 1.00 | 1.00 | 1.00 | 1.00 | 1.00 |
| Molecular weight Mw | 20 | 18 | 18 | 30 | 30 | 5 | 50 | 10 |
| (ten thousand) | | | | | | | | |
| Foam cell diameter | 100 | 110 | 90 | 100 | 110 | 90 | 100 | 110 |
| (μm) | | | | | | | | |
| Density (g/cm³) | 0.5 | 0.5 | 0.5 | 0.5 | 0.5 | 0.5 | 0.5 | 0.5 |
| Reusability | ⊚ | ⊚ | ◯ | ⊚ | ◯ | ◯ | ◯ | ◯ |
| High-temperature | ⊚ | ◯ | ⊚ | ◯ | ⊚ | ⊚ | ⊚ | ⊚ |
| durability | | | | | | | | |
| Flexibility | ◯ | ◯ | ◯ | ◯ | ◯ | ◯ | ◯ | ◯ |

| | | | | | | Comparative | | |
|---|---|---|---|---|---|---|---|---|
| | | Example | | | | example | | |
| Polyol | Kind | PEA | PEA | PEA | PEA | PEA | PEA | PEA |
| component | Proportion | 82 | 82 | 82 | 82 | 83 | 81 | 82 |
| | (wt %) | | | | | | | |
| Isocyanate | Kind | NDI | NDI | NDI | NDI | NDI | NDI | NDI |
| component | Proportion | 14 | 14 | 14 | 14 | 13 | 15 | 14 |
| | (wt %) | | | | | | | |

| | | | | | | | |
|---|---|---|---|---|---|---|---|
| Proportion of short- | 2.5 | 2.5 | 2.5 | 2.5 | 2.5 | 2.6 | 2.5 |
| chain polyol (wt %) | | | | | | | |
| NCO index (NCO/OH) | 1.00 | 1.00 | 1.00 | 1.00 | 0.87 | 1.05 | 1.00 |
| Molecular weight Mw | 20 | 20 | 20 | 20 | 10 | 10 | 30 |
| (ten thousand) | | | | | | | |
| Foam cell diameter | 50 | 500 | 90 | 110 | 90 | 110 | — |
| (μm) | | | | | | | |
| Density (g/cm³) | 0.5 | 0.5 | 0.3 | 0.8 | 0.5 | 0.5 | 1 |
| Reusability | ◯ | ◯ | ◯ | ◯ | ◯ | X | ◯ |
| High-temperature | ◯ | ◯ | ◯ | ◯ | X | ◯ | ◯ |
| durability | | | | | | | |
| Flexibility | ◯ | ◯ | ◯ | ◯ | ◯ | ◯ | X |

From the results in Table 1, it can be understood that the polyurethane molded products of Examples have both reusability and high-temperature durability, and exhibit higher flexibility.

On the other hand, the polyurethane molded product of Comparative Example 1 had a good foaming state, but an NCO index of a molded material was lower than a range (0.9 to 1.04) defined by the present disclosure, resulting in poor high-temperature durability. The polyurethane molded product of Comparative Example 2 also had a good foaming state, but an NCO index of a molded material was higher than the range (0.9 to 1.04) defined by the present disclosure, resulting in poor reusability. The polyurethane molded product of Comparative Example 3 had an NCO index within the range (0.9 to 1.04) defined by the present disclosure, but was not foamed and had poor flexibility.

Although specific embodiments of the present disclosure have been described in the above examples, the above examples are merely illustrative and should not be construed as limiting. Various modifications apparent to those skilled in the art are intended to be within the scope of the disclosure.

### INDUSTRIAL APPLICABILITY

This vibration isolating and damping member is suitable for applications in which high-temperature durability (heat deformation resistance) is required, and can be suitably applied to various vibration isolating and damping members such as engine mounts for automobiles, transmission mounts, body mounts, cab mounts, member mounts, connecting rods, torque rods, strut bar cushions, center bearing supports, torsional dampers, steering rubber couplings, tension rod bushes, bushes, bound stoppers, FF engine roll stoppers, and muffler hangers, in addition to bumper springs mounted in piston rods of shock absorbers.

In addition, since this vibration isolating and damping member has high reusability, for example, it is possible to heat-melt an old vibration isolating and damping member to reuse as a vibration isolating and damping member exhibiting the same mechanical properties as before, or to recycle it into another material.

1. A vibration isolating and damping member formed of polyurethane, wherein:
a polyol component of the polyurethane includes a polyester-based polyol excluding a short-chain polyol;
an isocyanate component of the polyurethane contains 1,5-naphthalenediisocyanate as a main component; and
the vibration isolating and damping member comprises a foam of a thermoplastic urethane composition having an NCO index of 0.9 to 1.04.

2. The vibration isolating and damping member according to claim 1, wherein a proportion of the isocyanate component in the thermoplastic urethane composition is 10 to 30% by mass.

3. The vibration isolating and damping member according to claim 1, wherein the polyurethane has a weight average molecular weight of 50,000 to 500,000.

4. The vibration isolating and damping member according to claim 1, wherein the polyester-based polyol is at least one selected from a group of polyethylene adipate, polycaprolactam, and polycarbonate diol.

5. The vibration isolating and damping member according to claim 1, wherein the foam has a density of 0.3 to 0.8 g/cm³.

6. The vibration isolating and damping member according to claim 1, wherein a number average diameter of foam cells in the foam is 50 to 500 km.

7. A method of manufacturing the vibration isolating and damping member according to claim 1, comprising:
preparing the urethane prepolymer from the polyester-based polyol and the isocyanate component containing 1,5-naphthalenediisocyanate as the main component;
mixing the urethane prepolymer with a remaining polyol component to prepare the thermoplastic urethane composition having an NCO index of 0.9 to 1.04;
molding a polyurethane foam formed of the thermoplastic urethane composition; and
separating the polyurethane foam from a molding die.

8. The method according to claim 7, wherein the molding of the polyurethane foam formed of the thermoplastic urethane composition is defined as:
pelletizing the thermoplastic urethane composition temporarily,
melting pellets with an injection molding machine, and
casting the pellets in a foamed state into a molding die to mold the polyurethane foam.
